(19) United States
(12) Patent Application Publication
(10) Pub. No.: US 2026/0166936 A1
(43) Pub. Date: Jun. 18, 2026

(54) FUNCTIONAL INDICATOR SYSTEMS FOR TRACTOR TRAILER CONNECTION

(71) Applicant: Timothy Daniel Dunn, Falconer, NY (US)

(72) Inventor: Timothy Daniel Dunn, Falconer, NY (US)

(21) Appl. No.: 19/416,288

(22) Filed: Dec. 11, 2025

Related U.S. Application Data
(60) Provisional application No. 63/734,016, filed on Dec. 13, 2024.

(51) Int. Cl. B60D 1/64; B60K 35/215

(52) U.S. Cl. CPC B60D 1/64; B60K 35/215; B60K 2360/167

(57) ABSTRACT

Provided herein are functional indicator systems for tractor trailer connection having a first connector socket positioned on a tractor and/or a trailer and sized to receive a first connector plug forming a first end of a connector cable, one or more socket function sensors configured to detect a presence or absence of one or more electrical or communications functionalities in a corresponding second connector socket positioned on a tractor or trailer connected to a second connector plug forming a second end of the electrical cable, and an indicator display in electronic communication with the one or more socket function sensors, the indicator display configured to visually indicate the detected presence or absence of the one or more electrical or communications functionalities.

### CROSS REFERENCE TO RELATED APPLICATIONS

This application claims benefit under 35 U.S.C. § 119(e) of U.S. Provisional Application No. 63/734,016, filed on 13 Dec. 2024, entitled “FUNCTIONAL INDICATOR SYSTEMS FOR TRACTOR TRAILER CONNECTION,” the entirety of which is incorporated by reference herein.

### BACKGROUND

The traditional tractor to trailer connection has 7 pins that supply power when a function is needed. There is pressure in the market to add auxiliary power pins and data connectivity to allow more functions in the tractor to trailer connection. Examples are: Electronically controlled brakes as used in Europe now, system information (commonly known as telematics information) and surround view capabilities through cameras. These are only some of the coming needs. The market is very cost sensitive, and there will be components that are intentionally missing features that are not needed at the time of component purchase. Also, there is a lot of older equipment still in service for decades to come. So, the data connectivity may not be there because of old equipment or cost reduced components that are missing functionality. The invention provides a means for a vehicle operator to verify they have sufficient connectivity to provide the AUX power or data enabled functions of the tractor and trailer. This would be accomplished with a display or indicator lights on the socket or nearby the socket mounted to the same vehicle the socket is mounted to.

### SUMMARY

Described herein are functional indicator systems for tractor trailer connection that include an indicator display in communication with socket function sensors at a trailer-side connector socket and/or a tractor-side connector socket to detect and indicate available compatible functionality. In some embodiments, the indicator display can be integrated into the corresponding socket assembly, positioned proximate the corresponding socket assembly. on the tractor or trailer, and/or be remotely positioned (e.g., in a cab of the tractor or on an operator mobile device) to provide feedback to the operator regarding which functions are supported or enabled by the connector sockets, plugs, and cables as configured and/or the operational status of such functions.

In one aspect a functional indicator system for tractor trailer connection is provided. The system includes a first connector socket positioned on a tractor and/or a trailer and sized to receive a first connector plug forming a first end of a connector cable. The system also includes one or more socket function sensors configured to detect a presence or absence of one or more electrical or communications functionalities in a corresponding second connector socket positioned on a tractor or trailer connected to a second connector plug forming a second end of the electrical cable. The system also includes an indicator display in electronic communication with the one or more socket function sensors, the indicator display configured to visually indicate the detected presence or absence of the one or more electrical or communications functionalities.

In some embodiments, the indicator display is integrated within a housing of the first connector socket and/or the second connector socket. In some embodiments, the indicator display is integrated within the housing of the first connector socket. In some embodiments, a second indicator display is integrated within the housing of the second connector socket. In some embodiments, the indicator display includes an electronic display. In some embodiments, the electronic display is at least one of an LCD display, an OLED display, an LED display, a computer screen, a tablet screen, a touchscreen, any other suitable digital screen, or combinations thereof.

In some embodiments, the indicator display includes a lighted panel and the visual indications of the indicator display include one or more lamps. In some embodiments, each of the lamps includes one or more of an LED, an incandescent bulb, an electroluminescent bulb, or combinations thereof. In some embodiments, a color, an on/off status, or combinations thereof of each lamp of the indicator display indicate a connectivity status of the electrical or communications functionalities. In some embodiments, an off status of a particular one of the lamps indicates no connectivity associated with a corresponding one of the electrical or communications functionalities. In some embodiments, an on status of the particular one of the lamps indicates at least partial connectivity associated with the corresponding one of the electrical or communications functionalities. In some embodiments, an on status of a particular one of the lamps indicates no connectivity associated with a corresponding one of the electrical or communications functionalities. In some embodiments, an off status of the particular one of the lamps indicates at least partial connectivity associated with the corresponding one of the electrical or communications functionalities. In some embodiments, the color of a particular one of the lamps indicates a type and/or status of a corresponding one of the electrical or communications functionalities.

In some embodiments, the one or more electrical or communications functionalities include one or more of electrical continuity, voltage, amperage, electrical current, data connectivity, physical layer connectivity, protocol compatibility, controller area network (CAN) connectivity, ethernet connectivity, wireless connectivity, or combinations thereof. In some embodiments, the indicator display is separate from and in electronic communication with the connector socket. In some embodiments, the indicator display is one or more of directly wired to the connector socket, connected to the connector socket via a wired network connection, connected to the connector socket via a wireless connection, or combinations thereof. In some embodiments, the indicator display is located in a cab of the tractor. In some embodiments, the indicator display is located on a mobile device, a tablet, or a laptop computer. In some embodiments, the visual indications of the indicator display include one or more graphical elements. In some embodiments, the visual indications of the indicator display include one or more text messages. In some embodiments, the visual indications of the indicator display are configured to be dimmed or shut off responsive to detection by one or more of the socket function sensors and/or a tractor controller that the tractor and/or trailer is moving. In some embodiments, the visual indications of the indicator display are configured to be brightened and/or turned on when the vehicle comes to a stop and/or is put in park.

In another aspect, a functional indicator assembly for tractor trailer connection is provided. The functional indicator assembly includes a housing. The functional indicator assembly also includes a connector socket retained within the housing and sized to receive a first connector plug forming a first end of a connector cable. The functional indicator assembly also includes one or more socket function sensors configured to detect a presence or absence of one or more electrical or communications functionalities in a corresponding second connector socket when a second connector plug forming a second end of the electrical cable is connected to the corresponding second connector socket. The functional indicator assembly also includes an indicator display retained within the housing and in electronic communication with the one or more socket function sensors, the indicator display configured to visually indicate the detected presence or absence of the one or more electrical or communications functionalities.

In some embodiments, the visual indications of the indicator display include at least one or more lamps, one or more graphical elements, one or more text messages, or one or more combinations thereof. In some embodiments, the visual indications of the indicator display are configured to be dimmed or shut off responsive to detection by one or more of the socket function sensors and/or a tractor controller that the tractor and/or trailer is moving. In some embodiments, the visual indications of the indicator display are configured to be brightened and/or turned on when the vehicle comes to a stop and/or is put in park.

### BRIEF DESCRIPTION OF THE DRAWINGS

FIG. 1A illustrates a side view of a connected tractor and trailer, wherein the tractor includes a tractor-side connector socket having an integrated tractor-side functional indicator display and the trailer includes a trailer-side connector socket having an integrated trailer-side functional indicator display.

FIG. 1B illustrates a rear view of the tractor including the tractor-side connector socket having the integrated tractor-side functional indicator display of FIG. 1A.

FIG. 1C illustrates a front view of the trailer including the trailer-side connector socket having the integrated trailer-side functional indicator display of FIG. 1A.

FIG. 2 illustrates a connector socket assembly having an integrated functional indicator.

FIG. 3A illustrates a side view of a connected tractor and trailer, wherein the tractor includes a tractor-side connector socket and a separate tractor-side functional indicator display and the trailer includes a trailer-side connector socket and a separate trailer-side functional indicator display.

FIG. 3B illustrates a rear view of the tractor including the tractor-side connector socket and the separate tractor-side functional indicator display of FIG. 3A.

FIG. 3C illustrates a front view of the trailer including the trailer-side connector socket and a separate trailer-side functional indicator of FIG. 3A.

FIG. 4 illustrates a side view of a connected tractor and trailer, wherein the tractor includes a tractor-side connector socket and a remote tractor-side functional indicator display located in a cab of the tractor and wherein the trailer includes a trailer-side connector socket and a remote trailer-side functional indicator display located on a different exterior side of the trailer than the trailer-side connector socket.

FIG. 5 illustrates a graphical user interface presenting graphical functional indicators on an electronic indicator display such as, for example, a display of a user mobile device, an electronic display installed in the cab of the tractor, or an electronic display installed on an exterior surface of the tractor or the trailer.

FIG. 6 illustrates a graphical user interface presenting text functional indicators on an electronic display such as, for example, a display of a user mobile device, an electronic display installed in the cab of the tractor, or an electronic display installed on an exterior surface of the tractor or the trailer.

FIG. 7 illustrates an indicator display having a plurality of indicator lamps.

### DETAILED DESCRIPTION

Provided herein are functional indicator systems for tractor trailer connection that include an indicator display in communication with socket function sensors at a trailer-side connector socket and/or a tractor-side connector socket to detect and indicate available compatible functionality. In some embodiments, the indicator display can be integrated into the corresponding socket assembly, positioned proximate the corresponding socket assembly on the tractor or trailer, and/or be remotely positioned (e.g., in a cab of the tractor, on a different side of the tractor or trailer from the corresponding socket assembly, or on an operator mobile device) to provide feedback to the operator regarding which functions are supported or enabled by the connector sockets, plugs, and cables as configured and/or the operational status of such functions.

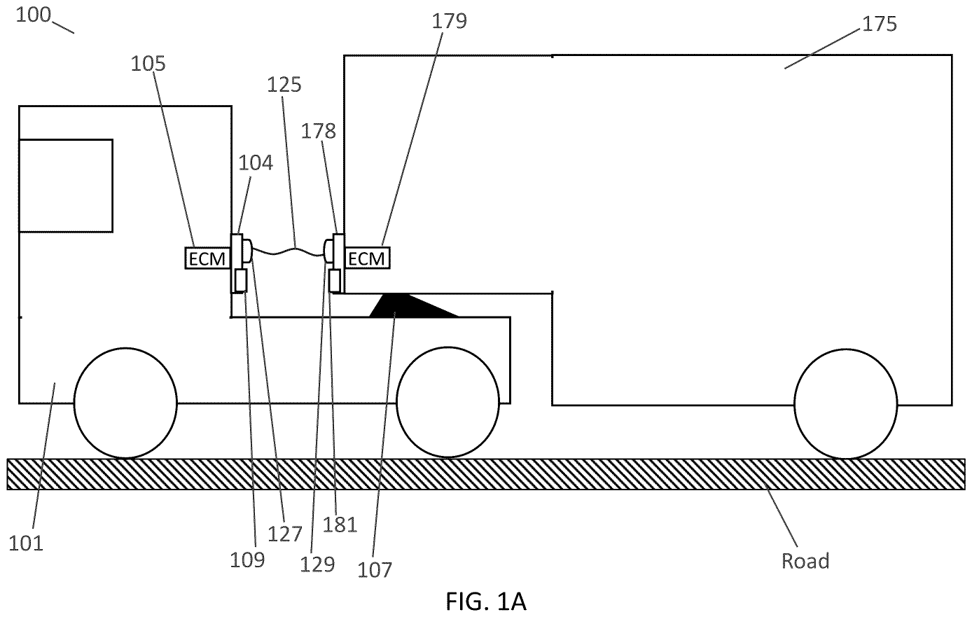

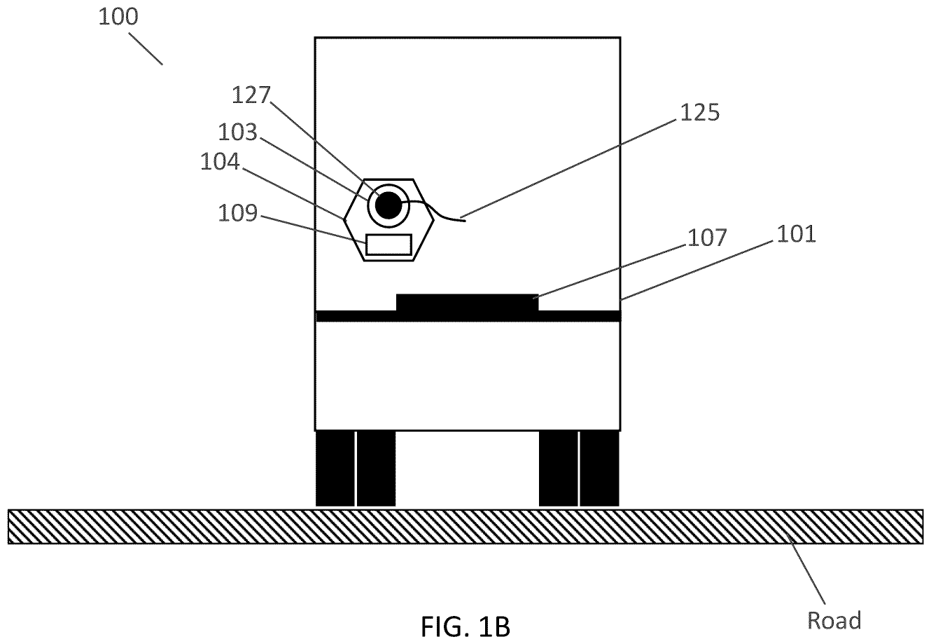

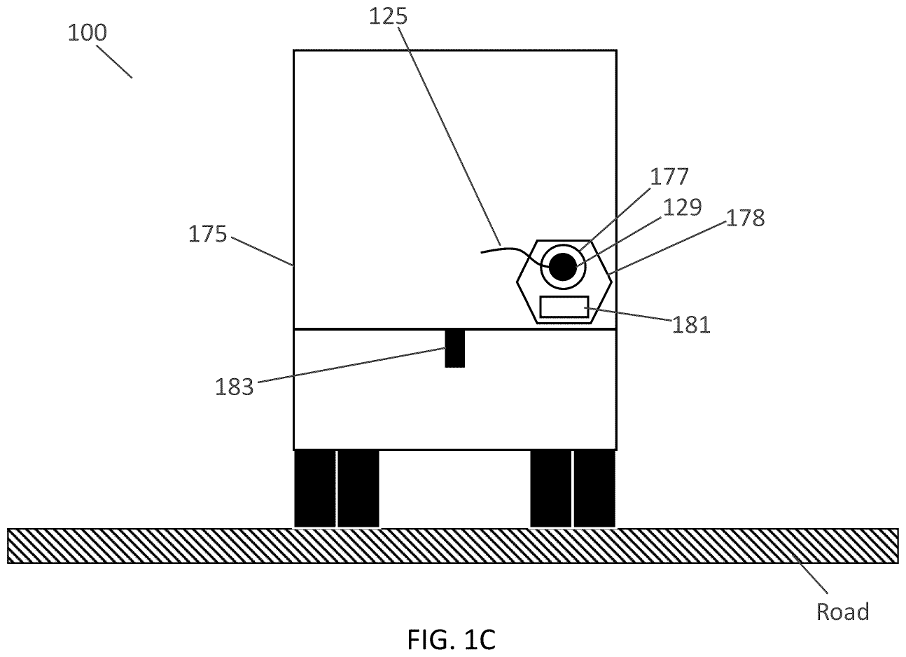

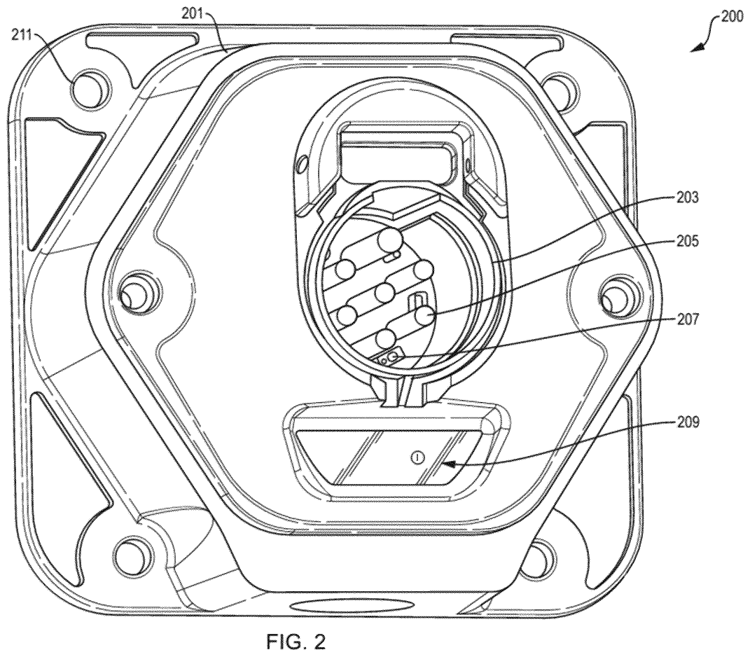

Referring now to FIGS. 1A-1C, a functional indicator system for tractor trailer connection 100 can include a tractor 101 having a hitch 107 (e.g., a fifth wheel as shown) for hitching the tractor to a trailer 175. As shown, the tractor 101 includes a tractor-side socket assembly 104 (see also FIG. 2) having a tractor-side socket 103 for receiving a tractor-side connector plug 127 of a connector cable 125 as well as an integrated tractor-side indicator display 109 for indicating, for example, availability, connectivity, and/or compatibility of various pins, connectors, and other electrical contacts of the tractor-side socket 103, The trailer 175 includes a trailer-side socket assembly 178 having a trailer-side socket 177 for receiving a trailer-side connector plug 129 of the connector cable 125 as well as an integrated trailer-side indicator display 181 for indicating, for example, availability, connectivity, and/or compatibility of various pins, connectors, and other electrical contacts of the trailer-side socket 177.

The connector cable 125 can be any suitable cable, coiled or not, having any suitable type of tactor- and trailer-side connector plugs 127, 129 and corresponding tractor- and trailer-side sockets 103, 177 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

In order to monitor status and functioning of the tractor 101 and/or the trailer 175, as well as providing various control functions with respect operation of the tractor 101 and/or the trailer 175, the tractor 101 can also include a tractor-side electronic control module 105 (“ECM” or “tractor controller”). The tractor-side ECM 105 can be configured for any number of functionalities including, for example, monitoring, tracking, and/or control over engine performance, emissions, transmission operation, braking systems, safety systems, lighting systems, connectivity between the tractor 101 and the trailer 175, trailer control signaling, driver clutch use, driver use of cruise control, driver braking habits, driver acceleration habits, speed, tire pressure, hitch status, any other aspect of the operation of the tractor 101 and/or trailer 175, or combinations thereof. Although shown herein as being positioned proximate or adjacent to the tractor-side socket assembly 104, the tractor-side ECM 105 can generally be located anywhere in the tractor 101 including, for example, anywhere in the cab.

In some embodiments, the trailer 175 can also include a corresponding trailer-side ECM 179 for providing two-way information exchange between the tractor 101 and the trailer 175, rather than limited one-sided monitoring and controlling by the tractor 101. In such embodiments, the trailer-side ECM 179 can monitor and report with respect to the operation of the trailer 175 including, for example, lighting systems, braking systems, tire pressure, trailer weight, hitch status, landing gear, latch and/or lock status of trailer doors, interior temperature, any other aspect of the operation of the trailer 175, or combinations thereof. In addition, in some embodiments, the trailer-side ECM 179 can report on available trailer functionalities, receive operational control commands from the tractor-side ECM 105, and/or control the trailer 175 according to control commands received from the tractor-side ECM 105. Although shown herein as being positioned proximate or adjacent to the trailer-side socket assembly 178, the trailer-side ECM 179 can generally be located in a nosebox of the trailer or at any other suitable location in the trailer 175.

The system 100 can be provided with one or more function sensors (not shown) for detecting a status of one or more pins or ports of a corresponding connector socket 103, 177. Such sensors can include, for example, electrical continuity sensors, voltage sensors, current sensors, amperage sensors, data connectivity sensors, transceivers and other circuitry for relaying data and communications signals to a corresponding ECM 105, 179 for determination of protocol compatibility, signal compatibility, and/or functionality reports from the connected tractor 101 or trailer 175. The function sensor data can be used by the corresponding ECM 105, 177 and/or the corresponding indicator display 109, 181 to provide the presented indications as explained below.

As shown in FIGS. 1A-1C, in some embodiments, the indicator display 109, 181 can be integrated into the corresponding socket assembly 104, 178 to provide feedback to the operator regarding which functions are supported or enabled by the ECMs, connector sockets, connector plugs, and connector cables as configured and/or the operational status of such functions. Such configurations can often advantageously facilitate simple installation and low cost of equipment, as well as being relatively convenient for retrofitting existing tractors 101 and/or trailers 175.

An example of socket assembly having an integrated indicator display is provided in FIG. 2. As shown, the socket assembly 200 includes a housing 201 having a connector socket 203 contained therein. The socket connector 203 includes a plurality of electrical contact pins 205 and several data connection ports 207. The socket assembly 200 also includes an integrated indicator display 209 which, as shown includes an electronic display for rendering graphical indicators (e.g., icons and/or symbols) and/or text indicators. As explained below, such integrated indicator displays 209 can alternatively or additionally include one or more indicator lamps. In some embodiments, the housing 201 can also include one or more fastening features such as bolt holes 211 for installing the socket assembly 200 into a tractor or trailer. In some embodiments the socket assembly can also include one or more function sensors for obtaining the displayed information from the connector socket 203.

Advantageously, such integrated socket assemblies 200 provide relatively low cost, simple installation, and convenient co-location of the indicator display 209 with the connector socket 203 for which the indicator display 209 provides information. In addition, because of the relatively small form factor and the fact that direct wiring need not be provided from the socket to the cab or other remote locations, such integrated socket assemblies 200 can be installed as a retrofit with low complexity installation and minimal (or no) physical modification to the retrofitted tractor or trailer.

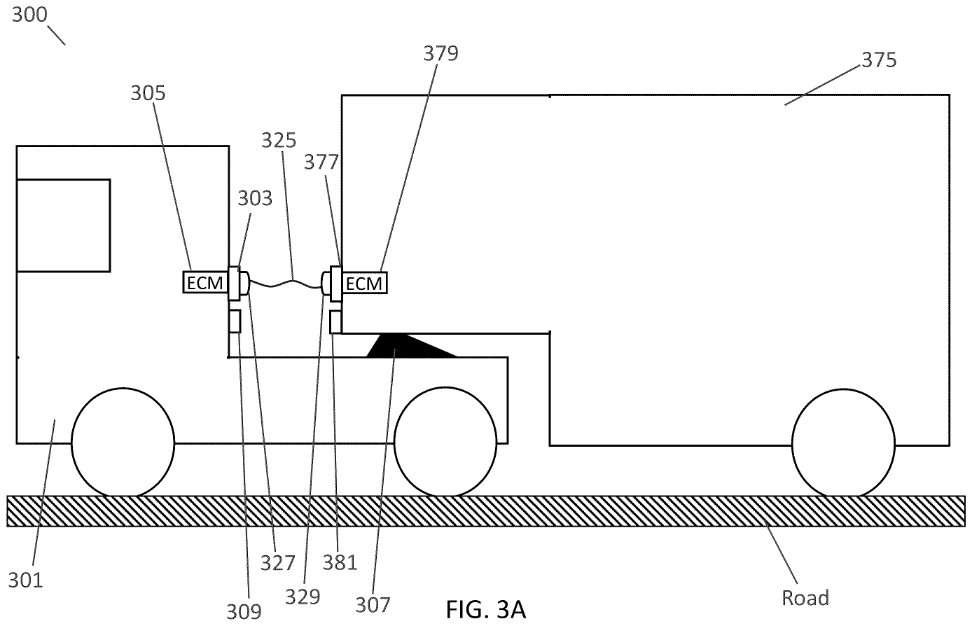

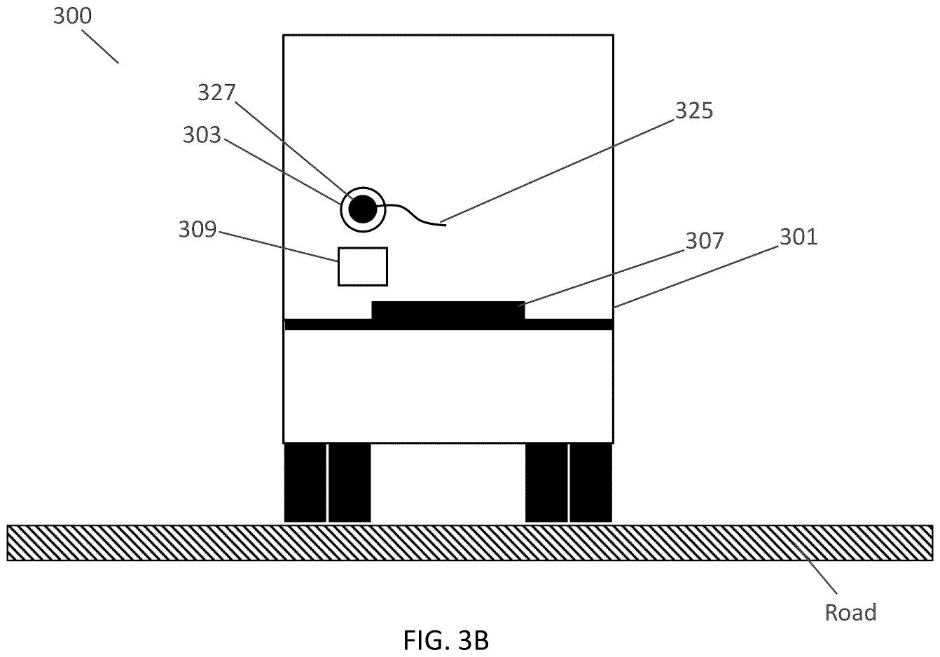

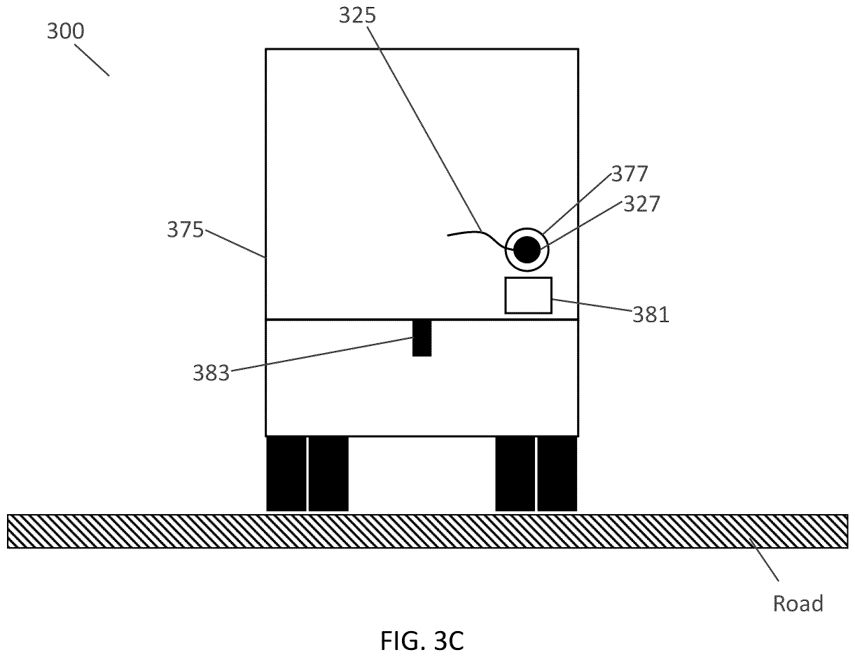

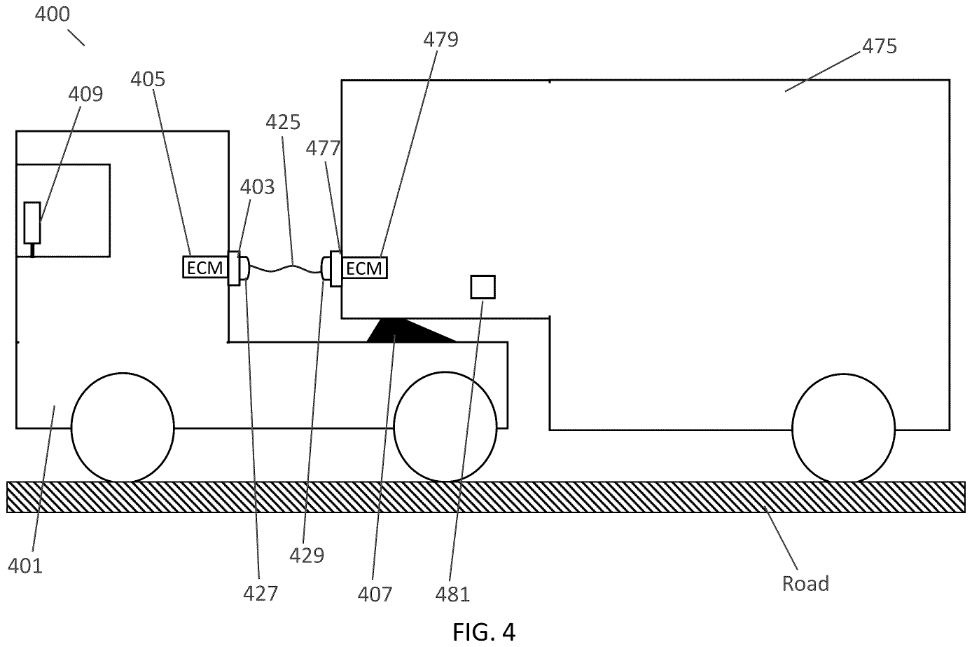

Alternatively or in addition, indicator displays can be provided that are separate from the corresponding socket. For example, as shown in FIGS. 3A-3C, indicator displays (e.g., tractor-side indicator display 309 and trailer side indicator display 381) can be positioned proximate to the corresponding socket e.g., tractor-side socket 303 or trailer-side socket 377) on the tractor 301 or trailer 375. Due to the close proximity to the corresponding socket 309, 377, such indicator displays 309, 381 can be connected to the corresponding socket, function sensors, and/or ECM by direct wire, by on-board ethernet, or wirelessly (e.g., Bluetooth, Wi-Fi, near-field communication (NFC), or cellular signal such as 3G, 4G, 5G, or 6G). As shown in FIG. 4, indicator displays can also be remotely positioned from the corresponding socket. For example, as shown in FIG. 4, a tractor-side indicator display 409 can be positioned in a cab of the tractor. As further shown in FIG. 4, such remote indicator displays can also be positioned on a different exterior surface of the tractor or trailer than the corresponding socket (e.g. trailer-side indicator display 481, located on a side of the trailer while the corresponding trailer-side socket 477 is located on a front of the trailer). Remote indicator displays can also be presented as graphical user interfaces on an operator mobile device such as, for example, a smartphone, a tablet, and/or a laptop computer having access to functional indicator program application and connectivity to the function sensors via, for example, the tractor-side ECM 105, 305, 405 and/or the trailer-side ECM 179, 379, 479. Such remote indicator displays can be connected to the corresponding socket, function sensors, and/or ECM by direct wire (e.g., when positioned in the cab or a different exterior surface), by on-board ethernet, or wirelessly (e.g., Bluetooth, Wi-Fi, or cellular signal such as 3G, 4G, 5G, or 6G).

Regardless of positioning, indicator displays 109, 181, 309, 381, 409, 481 can, in some embodiments, take the form of an electronic display (e.g., an LCD display, and OLED display, an LED display, a computer screen, a tablet screen, a touchscreen, any other suitable digital screen, or combinations thereof) and/or a lighted panel having one or more indicator lamps (e.g., LED lamps, incandescent lamps, electroluminescent lamps, any other suitable lamp, or combinations thereof). Such indicator displays 109, 181, 309, 381, 409, 481 may be specifically for the functional indicator system 100, 300, 400 or can instead be a multifunction display capable of being used for other purposes (e.g., a smartphone screen, tablet screen, or operator heads-up display (HUD) in the cab of the tractor).

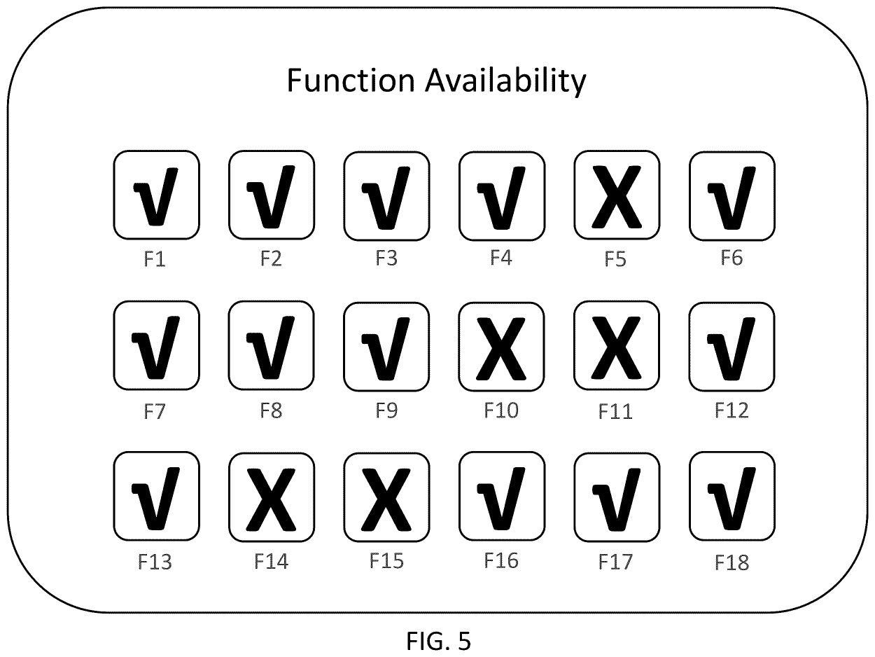

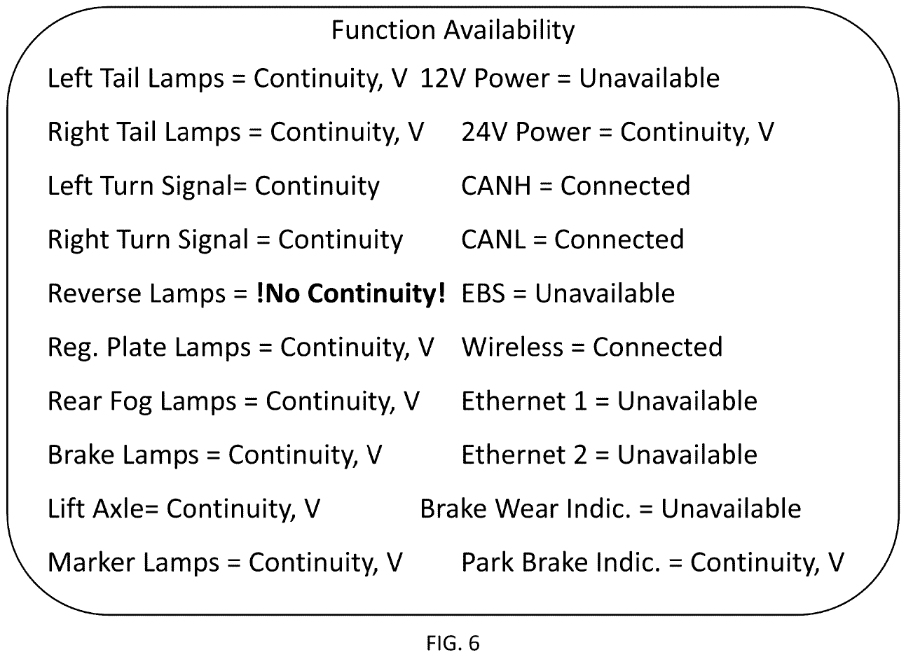

As shown in FIGS. 5 and 6, indicator displays 109, 181, 309, 381, 409, 481 taking the form of an electronic display can present graphical elements such as icons (FIG. 5) and/or text elements (FIG. 6) showing the status of one or more functions. For example, FIG. 5 shows an electronic indicator display having indicator icons for 18 functions. As shown, functions F5, F10, F11, F14, and F15 are indicated to be inactive, whether due to being unavailable, being incompatible, or malfunction. FIG. 6 shows an electronic indicator display having text indicating the status of several functions. As shown, functions such as 12V power, electropneumatic braking systems (EBS), ethernet, and brake wear indication are reported as unavailable under the current configuration of ECMs, connector sockets, connector plugs, and connector cables. Furthermore, it is reported that left and right turn signals have continuity but are inactive (not receiving a detected voltage), and the connector pin providing power to the reverse lamps appears to be malfunctioning as it lacks continuity.

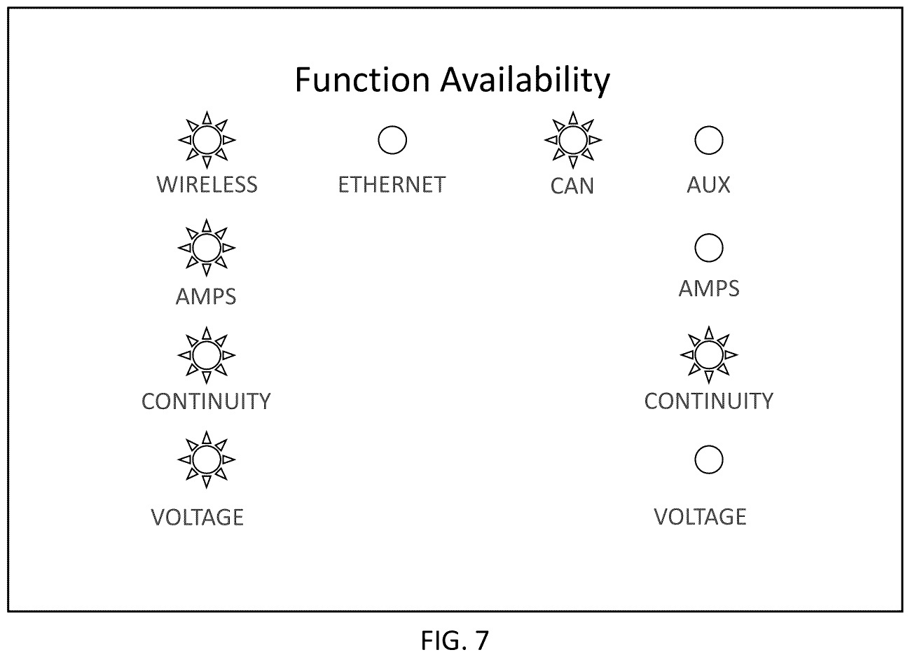

Alternatively or in addition, the indicator display can be a panel having one or more indicator lamps (e.g., LED, incandescent, electroluminescent, etc.). As shown in FIG. 7, such lamp panel indicator displays can include one or more indicator lamps, each having a label indicating which function the lamp corresponds to. Each such indicator lamp can provide information about a single connection within the corresponding socket or can instead represent a group of connections. For example, the indicator display of FIG. 7 indicates that a CAN network connection is connected but does not specify which of three possible pin or contact pairs is being used. Similarly, one indicator shows that there is no ethernet connection but does not indicate whether the connection is unavailable, incompatible, or malfunctioning. Alternatively, and preferably, each pin or pin pair would have its own indicator or indicators to indicate its function and/or operational status. For example, in FIG. 7, wireless functionality is connected and receiving a threshold amount of continuity, amperage, and voltage whereas auxiliary power has continuity but is inactive, receiving no voltage or amperage.

In some embodiments, the lamps can use a single-color on/off configuration for a binary indication of whether a particular function is operable or not. For example, as shown in FIG. 7, the lamps corresponding to ethernet and auxiliary power are both off, indicating that those functions are unavailable, incompatible, or malfunctioning. Similarly, the continuity indicator for auxiliary power is on but the corresponding voltage and amperage indicators are off, indicating connectivity but inactiveness. Meanwhile, wireless and CAN connectivity appear to be operative.

In some embodiments, status may also be indicated with multiple colors on fewer indicators or even a single indicator. For example, an indicator may be red when only a CAN connection is present, green when only an ethernet connection is present. and yellow when both a CAN connection and ethernet connection are present.

Lamp color may also be used to indicate differences between a complete connection and a partial connection. For example, in an ethernet connection, verifying connectivity may require a continuity check, a physical layer connection, and protocol compatibility. Colors of the indicators may be used to indicate the level of connection. For example:
OFF: no connectivity at all (continuity)
RED: Continuity is checked, but no data connectivity has been established
YELLOW: Continuity is checked, and there is some communication, but the communication is incomplete or there are errors.
GREEN: All levels of connectivity are established, and there are no errors

The status of AUX power pins can also be indicated to show continuity from tractor to trailer or presence of voltage. Indicators may be for AUX pins as a group, or a single indicator for each AUX pin. Where single-color indicators may indicate only a connection (continuity), multicolor indicators may use colors to further indicate the status of the AUX pin connection. For example:
OFF: no connectivity detected
YELLOW: continuity detected to the pin or one of the pins
GREEN: Voltage is present on the pin or one of the pins

More generally, indicator lamps of indicator displays can be provided in any number, with any number of patterns, combinations, and colors as appropriate and desired in connection with various embodiments and implementations. Additionally, although described above in the context of embodiments wherein one or more lamps being OFF indicates a lack of functionality and/or connectivity, in some embodiments the lamps can instead be turned ON and/or change to a specified color (e.g., red) to indicate such lack of functionality and/or connectivity.

Furthermore, indicator displays 109, 181, 309, 381, 409, 481 can exclusively use electronic displays, exclusively use indicator lamps, or can use combinations of both. Additionally, although not shown herein, in some embodiments, indicator displays 109, 181, 309, 381, 409, 481 can also be provided with audio functionality to, for example, provide an audible alert with respect to a critical system that is malfunctioning or improperly connected.

Furthermore, in some embodiments, the indicator displays 109, 181, 309, 381, 409, 481 can, responsive to detection by one or more of the socket function sensors and/or the corresponding ECM 105, 179, 305, 379, 405, 479 that the tractor and/or trailer is moving, dim or even shut off the indicator displays 109, 181, 309, 381, 409, 481 until the vehicle comes to a stop, is put in park, etc. This can be advantageous because there is a known issue wherein exteriorly visible lamps having a “fault color” (e.g., red) can cause a driver to be pulled over if the lamps are visibly illuminated while the vehicle is moving. This is because police officers cannot tell if the indicator is indicating functionality or indicating a safety fault. By dimming or turning off the indicator displays 109, 181, 309, 381, 409, 481 during movement of the vehicle, this risk is reduced or eliminated.

Referring now to FIGS. 3A-3C, a functional indicator system for tractor trailer connection 300 can include a tractor 301 having a hitch 307 (e.g., a fifth wheel as shown) for hitching the tractor to a trailer 375. As shown, the tractor 301 includes a tractor-side socket 303 for receiving a tractor-side connector plug 327 of a connector cable 325 as well as a separate, proximately located tractor-side indicator display 309 for indicating, for example, availability, connectivity, and/or compatibility of various pins, connectors, and other electrical contacts of the tractor-side socket 303, The trailer 375 includes a trailer-side socket 377 for receiving a trailer-side connector plug 329 of the connector cable 325 as well as a separate, proximately located trailer-side indicator display 381 for indicating, for example, availability, connectivity, and/or compatibility of various pins, connectors, and other electrical contacts of the tractor-side socket 377 as described above.

The connector cable 325 can be any suitable cable, coiled or not, having any suitable type of tactor- and trailer-side connector plugs 327, 329 and corresponding tractor- and trailer-side sockets 303, 377 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

In order to monitor status and functioning of the tractor 301 and/or the trailer 375, as well as providing various control functions with respect operation of the tractor 301 and/or the trailer 375, the tractor 301 can also include a tractor-side electronic control module 305 (“ECM” or “tractor controller”). The tractor-side ECM 305 can be configured for any number of functionalities including, for example, monitoring, tracking, and/or control over engine performance, emissions, transmission operation, braking systems, safety systems, lighting systems, connectivity between the tractor 301 and the trailer 375, trailer control signaling, driver clutch use, driver use of cruise control, driver braking habits, driver acceleration habits, speed, tire pressure, hitch status, any other aspect of the operation of the tractor 301 and/or trailer 375, or combinations thereof. Although shown herein as being positioned proximate or adjacent to the tractor-side socket 303, the tractor-side ECM 305 can generally be located anywhere in the tractor 301 including, for example, anywhere in the cab.

In some embodiments, the trailer 375 can also include a corresponding trailer-side ECM 379 for providing two-way information exchange between the tractor 301 and the trailer 375, rather than limited one-sided monitoring and controlling by the tractor 101. In such embodiments, the trailer-side ECM 379 can monitor and report with respect to the operation of the trailer 375 including, for example, lighting systems, braking systems, tire pressure, trailer weight, hitch status, landing gear, latch and/or lock status of trailer doors, interior temperature, any other aspect of the operation of the trailer 375, or combinations thereof. In addition, in some embodiments, the trailer-side ECM 379 can report on available trailer functionalities, receive operational control commands from the tractor-side ECM 305, and/or control the trailer 375 according to control commands received from the tractor-side ECM 305. Although shown herein as being positioned proximate or adjacent to the trailer-side socket 377, the trailer-side ECM 379 can generally be located in a nosebox of the trailer or at any other suitable location in the trailer 375.

The system 300 can be provided with one or more function sensors (not shown) for detecting a status of one or more pins or ports of a corresponding connector socket 303, 377. Such sensors can include, for example, electrical continuity sensors, voltage sensors, current sensors, amperage sensors, data connectivity sensors, transceivers and other circuitry for relaying data and communications signals to a corresponding ECM 305, 379 for determination of protocol compatibility, signal compatibility, and/or functionality reports from the connected tractor 301 or trailer 375. The function sensor data can be used by the corresponding ECM 305, 377 and/or the corresponding indicator display 309, 381 to provide the presented indications as explained above.

Referring now to FIG. 4, a functional indicator system for tractor trailer connection 400 can include a tractor 401 having a hitch 407 (e.g., a fifth wheel as shown) for hitching the tractor to a trailer 475. As shown, the tractor 401 includes a tractor-side socket 403 for receiving a tractor-side connector plug 427 of a connector cable 425 as well as a remote tractor-side indicator display 409 (e.g., in the cab as shown) for indicating, for example, availability, connectivity, and/or compatibility of various pins, connectors, and other electrical contacts of the tractor-side socket 403, The trailer 475 includes a trailer-side socket 477 for receiving a trailer-side connector plug 429 of the connector cable 425 as well as a remote trailer-side indicator display 481 (e.g., positioned on a different side of the trailer 475) for indicating, for example, availability, connectivity, and/or compatibility of various pins, connectors, and other electrical contacts of the tractor-side socket 477 as described above.

The connector cable 425 can be any suitable cable, coiled or not, having any suitable type of tactor- and trailer-side connector plugs 427, 429 and corresponding tractor- and trailer-side sockets 403, 477 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

In order to monitor status and functioning of the tractor 401 and/or the trailer 475, as well as providing various control functions with respect operation of the tractor 401 and/or the trailer 475, the tractor 401 can also include a tractor-side electronic control module 405 (“ECM” or “tractor controller”). The tractor-side ECM 405 can be configured for any number of functionalities including, for example, monitoring, tracking, and/or control over engine performance, emissions, transmission operation, braking systems, safety systems, lighting systems, connectivity between the tractor 401 and the trailer 475, trailer control signaling, driver clutch use, driver use of cruise control, driver braking habits, driver acceleration habits, speed, tire pressure, hitch status, any other aspect of the operation of the tractor 401 and/or trailer 475, or combinations thereof. Although shown herein as being positioned proximate or adjacent to the tractor-side socket 403, the tractor-side ECM 405 can generally be located anywhere in the tractor 401 including, for example, anywhere in the cab.

In some embodiments, the trailer 475 can also include a corresponding trailer-side ECM 479 for providing two-way information exchange between the tractor 401 and the trailer 475, rather than limited one-sided monitoring and controlling by the tractor 401. In such embodiments, the trailer-side ECM 479 can monitor and report with respect to the operation of the trailer 475 including, for example, lighting systems, braking systems, tire pressure, trailer weight, hitch status, landing gear, latch and/or lock status of trailer doors, interior temperature, any other aspect of the operation of the trailer 475, or combinations thereof. In addition, in some embodiments, the trailer-side ECM 479 can report on available trailer functionalities, receive operational control commands from the tractor-side ECM 405, and/or control the trailer 475 according to control commands received from the tractor-side ECM 405. Although shown herein as being positioned proximate or adjacent to the trailer-side socket 477, the trailer-side ECM 479 can generally be located in a nosebox of the trailer or at any other suitable location in the trailer 475.

The system 400 can be provided with one or more function sensors (not shown) for detecting a status of one or more pins or ports of a corresponding connector socket 403, 477. Such sensors can include, for example, electrical continuity sensors, voltage sensors, current sensors, amperage sensors, data connectivity sensors, transceivers and other circuitry for relaying data and communications signals to a corresponding ECM 405, 479 for determination of protocol compatibility, signal compatibility, and/or functionality reports from the connected tractor 401 or trailer 475. The function sensor data can be used by the corresponding ECM 405, 477 and/or the corresponding indicator display 409, 481 to provide the presented indications as explained above.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A functional indicator system for tractor trailer connection comprising:
a first connector socket positioned on a tractor and/or a trailer and sized to receive a first connector plug forming a first end of a connector cable;
one or more socket function sensors configured to detect a presence or absence of one or more electrical or communications functionalities in a corresponding second connector socket positioned on a tractor or trailer connected to a second connector plug forming a second end of the electrical cable;
an indicator display in electronic communication with the one or more socket function sensors, the indicator display configured to visually indicate the detected presence or absence of the one or more electrical or communications functionalities.

2. The functional indicator system for tractor trailer connection of claim 1, wherein the indicator display is integrated within a housing of either the first connector socket and/or the second connector socket.

3. The functional indicator system for tractor trailer connection of claim 2, wherein:
the indicator display is integrated within the housing of the first connector socket; and
a second indicator display is integrated within the housing of the second connector socket.

4. The functional indicator system for tractor trailer connection of claim 1, wherein the indicator display includes an electronic display.

5. The functional indicator system for tractor trailer connection of claim 4, wherein the the electronic display is at least one of an LCD display, an OLED display, an LED display, a computer screen, a tablet screen, a touchscreen, any other suitable digital screen, or combinations thereof.

6. The functional indicator system for tractor trailer connection of claim 1, wherein the indicator display includes a lighted panel and the visual indications of the indicator display include one or more lamps.

7. The functional indicator system for tractor trailer connection of claim 6, wherein each of the lamps includes one or more of an LED, an incandescent bulb, an electroluminescent bulb, or combinations thereof.

8. The functional indicator system for tractor trailer connection of claim 6, wherein a color, an on/off status, or combinations thereof of each lamp of the indicator display indicate a connectivity status of the electrical or communications functionalities.

9. The functional indicator system for tractor trailer connection of claim 8, wherein:
an off status of a particular one of the lamps indicates no connectivity associated with a corresponding one of the electrical or communications functionalities; and
an on status of the particular one of the lamps indicates at least partial connectivity associated with the corresponding one of the electrical or communications functionalities.

10. The functional indicator system for tractor trailer connection of claim 8, wherein:
an on status of a particular one of the lamps indicates no connectivity associated with a corresponding one of the electrical or communications functionalities; and
an off status of the particular one of the lamps indicates at least partial connectivity associated with the corresponding one of the electrical or communications functionalities.

11. The functional indicator system for tractor trailer connection of claim 8, wherein the color of a particular one of the lamps indicates a type and/or status of a corresponding one of the electrical or communications functionalities.

12. The functional indicator system for tractor trailer connection of claim 1, wherein the one or more electrical or communications functionalities include one or more of electrical continuity, voltage, amperage, electrical current, data connectivity, physical layer connectivity, protocol compatibility, controller area network (CAN) connectivity, ethernet connectivity, wireless connectivity, or combinations thereof.

13. The functional indicator system for tractor trailer connection of claim 1, wherein the indicator display is separate from and in electronic communication with the connector socket.

14. The functional indicator system for tractor trailer connection of claim 13, wherein the indicator display is one or more of directly wired to the connector socket, connected to the connector socket via a wired network connection, connected to the connector socket via a wireless connection, or combinations thereof.

15. The functional indicator system for tractor trailer connection of claim 13, wherein the indicator display is located in a cab of the tractor.

16. The functional indicator system for tractor trailer connection of claim 13, wherein the indicator display is located on a mobile device, a tablet, or a laptop computer.

17. The functional indicator system for tractor trailer connection of claim 1, wherein the visual indications of the indicator display include one or more graphical elements.

18. The functional indicator system for tractor trailer connection of claim 1, wherein the visual indications of the indicator display include one or more text messages.

19. The functional indicator system for tractor trailer connection of claim 1, wherein the visual indications of the indicator display are configured to be dimmed or shut off responsive to detection by one or more of the socket function sensors and/or a tractor controller that the tractor and/or trailer is moving.

20. The functional indicator system for tractor trailer connection of claim 19, wherein the visual indications of the indicator display are configured to be brightened and/or turned on when the vehicle comes to a stop and/or is put in park.

21. A functional indicator assembly for tractor trailer connection comprising:
a housing;
a connector socket retained within the housing and sized to receive a first connector plug forming a first end of a connector cable;
one or more socket function sensors configured to detect a presence or absence of one or more electrical or communications functionalities in a corresponding second connector socket when a second connector plug forming a second end of the electrical cable is connected to the corresponding second connector socket;
an indicator display retained within the housing and in electronic communication with the one or more socket function sensors, the indicator display configured to visually indicate the detected presence or absence of the one or more electrical or communications functionalities.

22. The functional indicator assembly of claim 21, wherein the visual indications of the indicator display include at least one or more lamps, one or more graphical elements, one or more text messages, or one or more combinations thereof.

23. The functional indicator assembly of claim 21, wherein the visual indications of the indicator display are configured to be dimmed or shut off responsive to detection by one or more of the socket function sensors and/or a tractor controller that the tractor and/or trailer is moving.

24. The functional indicator assembly of claim 23, wherein the visual indications of the indicator display are configured to be brightened and/or turned on when the vehicle comes to a stop and/or is put in park.
